(19) United States
(12) Patent Application Publication
(10) Pub. No.: US 2006/0031126 A1
(43) Pub. Date: Feb. 9, 2006

(54) Method and for facilitating network communication between a wireless device and a service system via an interface

(75) Inventors: David Yin-Shur Ma, San Jose, CA (US); Frank Yu, Fremont, CA (US)

Correspondence Address: STEVENS LAW GROUP, P.O. BOX 1667, SAN JOSE, CA, 95109, US

(73) Assignee: Clarinet Systems, Inc., Fremont, CA (US)

(21) Appl. No.: 11/177,178

(22) Filed: Jul. 7, 2005

Related U.S. Application Data
(63) Continuation-in-part of application No. 10/922,534, filed on Aug. 19, 2004.
Application No. 10/922,534 is a continuation-in-part of application No. 09/772,451, filed on Jan. 29, 2001.
Application No. 09/772,451 is a continuation-in-part of application No. 09/733,312, filed on Dec. 8, 2000, now Pat. No. 6,976,075.

(51) Int. Cl. G03G 15/00

(52) U.S. Cl. 705/26; 399/12

(57) ABSTRACT

A wireless communication system is provided to enable a wireless communication interface configured to communicate with a wireless device, then to further communicate with a network interface configured to facilitate communication between the communication interface and a network, where the network is configured to facilitate communication among devices that communicate with the network. The system is able to establish communication link with the application server retrieving wireless user related information and content from the wireless device; and communicate with the application server to transmit user information received from the wireless device and related content.

### RELATED APPLICATIONS

This is a continuation in part of co-pending and commonly assigned U.S. patent application Ser. No. 09/733,312, entitled Method and Apparatus for Facilitating Communication between a Personal Data Assistant and a Computer, filed Dec. 8, 2000; and a continuation in part of co-pending and commonly assigned U.S. patent application Ser. No. 09/772,451, entitled Method and Apparatus for Facilitating Communication Between a Wireless device and Disparate Devices or Systems, filed Jan. 29, 2001, and a continuation in part of co-pending U.S. application Ser. No. 10/922,534, entitled Method and interface for Facilitating Communication of Location Specific Contents Between a Wireless Device and Other Devices or Systems Via an Interface, filed Aug. 19, 2004, all of which are incorporated by reference.

### BACKGROUND

The invention relates generally to communication between a wireless device, such as a personal data assistant (wireless device) or cell phone and a wireless access point or computer, more particularly, to a method and interface for the wireless device to upload information such as photos and data related to a local access point, and to further facilitate dissemination of the information via a network, such as the internet.

A wireless device such as a wireless device or cell phone is generally a portable device configured to store data and perform basic functions for a user to view, receive, transmit, store and consume data. Different types of wireless devices and cell phones are well known in the consumer electronics industry and are currently in widespread use. One popular wireless device is the Palm Pilot™, made by Palm™. This device runs on a specialized operating system, known as PalmOS™. Other wireless devices may be configured under different operating systems, such as the WindowsCE™ and the PocketPC™ that run under operating systems that are developed and sold by Microsoft Corporation™.

Modern cellular telephones may be configured similarly to wireless devices, providing any and all of the conventional functions of wireless devices. Two popular features of modern cellular phones are still and video cameras. The quality of these camera features are quickly improving with innovations in the market, and are absorbing a larger part of the camera market as these improvements increase. Among many improvements are higher resolution features, such as cameras havign resolutiojn ihn the mega-pixel range, over one million pixesl per square inch. Still photos in this resolution range require substantial storage capacity. Such capacity quickly fills up, particularly when a user is on vacation, taking many photos, video motion pictures takes even more storage space. Most users need to carry extra storage devices, laptops, and other devices just to capture enough data to preserve the video or photos. This is inconvenient, cumbersome and expensive. Most devices require uploading via a physical cable to a storage device. Several wireless devices exist that enable uploading of photo data for storage, but none of them allow automatic storage features, are not portable, and further require more hardware to operate. And, storage requires extra effort and the use of a personal computer to properly store or transmit the data.

These phones may also offer internal software applications such as an address book for keeping names and addresses, a calendar for keeping schedules and important dates, a notebook for keeping notes, an Internet application for accessing the Internet to send and receive E-mail and other services, specialized applications for communicating with computer servers over a network and other applications.

Most conventional wireless devices include the ability to communicate with a computer system via a network, such as an Ethernet. One method of performing such communication is to dial up a connection with a computer server that is connected to network via an infrared access point connected to a local area network (LAN). Such a connection is known as a LAN access point, or LAP. The protocol used to communicate with the server is known as the TCP/IP/PPP protocol. This is a protocol commonly used in the industry of data communications. This protocol requires a great deal of computer processing power in order to perform a data transfer. One major problem is that the wireless device can not tell where the LAP is located and cannot know the correlation of the residence between a LAP and a store unless the wireless device or the device user performs a specific task to figure this out.

Cellular phones, though they are configured with multiple features as PDAs (digital cameras, user interfaces for viewing photos, text, and other information), the transmission of photo, video, audio, text and other data requires the use of the cellular telephone network. Providers of cellular services charge for all types of transmissions, often separately, leading to a very expensive cellular phone bill for the average user. To illustrate a practical application that utilizes a wireless device, a cellular telephone may be used to download or upload information, such as photos or text messages. In operation, a user can connect with the cellular network to send, for example, photos and messages. The cellular provider for the phone typically charges for the time spent connected to then network, charges separately for each upload, particularly for photos and text messages, and involves connection with a cellular network that can be slow and cumbersome. This makes such communication expensive. Also, a user needs to connect to the cellular network in order to upload text or photos at public locations, which is problematic. Conventional processes are expensive, because you need to pay for airtime to upload photos via the cellular network, and roaming around can cause a user's connection to be dropped from the system, leaving the user to reconnect and start over.

Many conventional cellular telephones offer features typically found in wireless devices, and even offer interactive services to a user, but their services are seldom relevant or adaptable to specialized wireless device applications. Also, access to a cellular network is limited to the range of the cellular phone system. In most situations, access and support for particular applications can be lacking.

In sum, cellular networks cost money to use. Photo uploads require a large amount of data as well as the time to upload it using the cellular network. Text messages also cost money to send, as they are separately charged. Some specialty phones are available that use Bluetooth™ technology that allows uploading to a personal computer for printing. This, however, is not convenient, not portable, and requires the use of a specially configured computer to receive the signal for simply printing.

If location specific information is required, a local venue such as a restaurant or a store cannot deliver location specific information to the cell phone through the cellular network while the phone user is visiting the store, since the cellular network cannot pinpoint to an exact location of the cell phone unless some human involved procedures—to identify the location and access a particular application, connect to a network, and send and receive information of location specific are taken. The “location” can mean for example a fast food restaurant on xyz street of a city, or a store in a mall, or gate xyz of a terminal of an airport. In many cases, this process can be burdensome to a user. Also, if access is burdensome or time consuming, the user will not bother using convenient services at a particular location, losing out on its benefits. Furthermore, support for an application in a particular and unique location can be unavailable given a user's cellular phone provider and whatever services are provided. Such a system may need weekly, daily, hourly or real time updates and maintenance by people familiar with the business. Cellular service providers, therefore, do not provide such specialized services because they do not have the infrastructure or the expertise required to create and maintain systems capable of providing such services.

Therefore, it would be useful to develop a device and method for more efficiently and intelligently transferring data between a wireless device, such as a mobile phone, and a computer server that does not suffer from the drawbacks of conventional cellular phone network transmissions. Such a system should also be less burdensome on the digital memory storage and the data processor of the wireless device, and less costly and burdensome on the user to upload content, such as photo data, and to receive such content as well. This would also enable a cellular phone user to upload content, such as text, photos and other data, without needing to access the cellular network, avoiding the dependence on the cellular network support in order to operate the function. It might further enable a cell phone to download local, national or international national content, such as coupons of any store or offers for travel, without having to store a specific application. As will be seen, the invention provides such a device and method that accomplishes these goals in an elegant manner.

### SUMMARY OF THE INVENTION

A system and method for uploading and downloading content such as photo related data from a wireless device such as a mobile phone, where the method includes receiving a packet having an embedded information address and command from a wireless device that is enabled with a protocol to establish a communication link with an application server; establishing communication link with the application server; retrieving content data from the wireless device for storage and transmission; automatically transmitting the content data to the data application server according to a wireless user's predetermined destination information; and forwarding the content data to at least one predetermined destination.

### BRIEF DESCRIPTION OF THE DRAWINGS

FIGS. 1A and 1B are block diagrams of a system for communicating between a wireless device and an interface according to the invention;

FIG. 2 is a block diagram of a wireless device configured to operate according to the invention;

FIG. 3 is a block diagram of a communications interface according to the invention;

FIG. 4 is a block diagram of a central wireless user server configured to operate according to the invention;

FIG. 5 is a flow chart of an upload operation according to the invention;

FIG. 6 is a flow chart of an upload operation according to the invention;

FIG. 7 is a flow chart of an upload operation according to the invention;

FIGS. 8A and 8B are flow chart of a process for transmitting data with a wireless device according to the invention;

FIG. 9 is system diagram of a wireless service system according to the invention;

FIG. 10 is a flow chart of a process transmitting localized information from a computer to a wireless device according to the invention; and

FIG. 11 is a flow chart of a process transmitting localized information from a computer to a wireless device according to the invention.

### DETAILED DESCRIPTION

The invention provides a communication interface that is configured to exchange digital data packets with a wireless device, such as a cellular phone configured with photo and video features, or other device, and is further configured to locally exchange digital data at a service interface. The interface can further communicate with a device such as a computer server communicating with a network, such as the Internet. This provides a system for a photo-capable mobile phone user to upload photo information at a local interface point, such as a kiosk, where the interface is further configured to receive the photo upload information and to further transmit it to remote locations, such as IP addresses on the Internet.

In operation, a user submits user information pertaining to a portable transmission device, such as a mobile phone for example. This may be done in a number of ways. In one configuration, the control of the processing may be solely in the interface that receives the photo data transmission. The control of the photo upload from the sender's point of view, such as a mobile phone for example, may simply be a transmission of photo data from a transmission device, such as an appropriately configured mobile telephone with photo capabilities, a wireless device, a camera, or other device, via a infra red (IR) signal, a Bluetooth™ signal, or other signal to a receiver interface. The interface can take the photo data and process it without any further input from the transmission device. In this configuration, the transmission criteria data needs to be submitted to the interface. The interface may have a default set of criteria, such as a process that simply stores the uploaded photo data until further instructed.

Once the photo data us uploaded, a user may then input data subsequent to the transmission that dictates the processing of the uploaded data. The user may submit destination addresses to where delivery of the photo data can be performed. This may be done at the upload location, where an input device is set up to receive a user's information, including-user identification, destination information such as an email address for example, and other information pertinent to the upload process. Other information may be input as well, such as marketing information that can be used for market research, payment information is the service charges a fee, and other information.

The user may have previously submitted the destination criteria prior to uploading the photo data. For example, a website may be configured for mobile phone/camera users to sign up for a photo upload service. The user would then be better prepared to upload photos, saving time from inputting the user information at the time of uploading.

In either configuration, once the information is in the system, a user can more easily upload photo data and have it processed automatically. In one example, the photo data may automatically be transmitted to an email address for later retrieval by the user. The user may also configure the system to send the photo data to other destinations, such as email addresses of family and friends, a designated database located at an address, or to other locations. For example, a user may simply enter a user name and password before uploading photo data, upload the data, and the photo data is transmitted automatically to predetermined destinations.

In yet another embodiment, a user may have a device that is preprogrammed to send user information from the device at the time of uploading. This would require a software application and related hardware for transmitting user information along with photo data.

In one application, local information can be uploaded and downloaded from a cellular telephone configured to transmit and receive localized information that pertains to a location where a user operates

For example, a user may bring a wireless device, or a cellular phone operating as a wireless device, to a fast food restaurant and beam up menu information, coupons, daily specials, and other information. This information can be viewed by a user before an order is made, and can be interactive in nature. It is also possible for further features, such as questions sent and answers received, actual orders made, updating information, and other features. A remote or local server is utilized to maintain relevant information that is relevant to the location. When this user brings the same wireless device to a store next or near to this fast food restaurant, the wireless device will receive localized information that pertains to the store according to this invention.

When directed to exchange data between a wireless device and a computer, the interface is capable of converting the header of a data packet from one header format to another header format. This allows seamless communication between the computer and the wireless device. The typical communication between the wireless device and other devices is not interactive, but rather relatively simple data downloads and uploads. Therefore, complex header protocols required for universal communication with other devices, including devices connected to the Internet, are not necessary for a wireless device. Using the interface, the complex computations and extensive data storage required to make data transactions can be offloaded from the wireless device to the interface. The interface can then perform the direct communication with a computer server or other device that is connected to a network, such as the Internet.

In operation, the communication interface may receive the data packet transmitted from the wireless device under the first header format, destined for a computer connected to a network such as the Internet, and convert the header associated with the data packet to the second header format. The interface can then transmit the data packet having the reformatted header to the computer server via the network for processing.

Different types of communication protocols can be used. One popular protocol is Blue Tooth protocol, which is a standard communication protocol for use in wireless devices. The invention is described in connection with a new type of communication protocol below, but is not limited to any particular protocol, and includes all types of communication methods and mediums. The invention is not limited to any particular method or medium.

Similarly, the communication interface is further configured to receive the data packet having the second header format and transmitted from the computer server, convert the associated header from the second header format to the first header format and then transmit the data packet having the reformatted header to the wireless device. The inclusion of such a communication interface in a computer system reduces the amount of overhead data required to send data to and from the wireless device. Employing the interface also reduces the amount of computation required of the wireless device to receive and transmit the data. The invention may be extended to include the execution of other complex operations for the wireless device for which the wireless device may not have the memory or processing capacity. The invention is applicable to all types of wireless devices, including cellular telephones configured as wireless devices and many other types of devices.

The invention may include a communication interface for enabling communicating between a wireless device or personal data assistant (wireless device) and a device connected to a network such as computer server. Typical communication between the wireless device and other devices is not interactive, but rather relatively simple downloads and uploads of data packets. Therefore, according to the invention, complex header protocols required for universal communication with other devices, including devices that communicate via the Internet, are not necessary. To this end, a communication interface is provided for performing the complex header protocols for the wireless device, with the communication interface acting as an interface between the wireless device and other conventional devices. The communication interface may have an IP address associated with the wireless device so that it may send and receive transmissions of data on its behalf. This way, any device connected to the Internet can send the wireless device data. The interface may then intercept such data transmissions and process them according to the invention. Thus, the wireless device may operate entirely transparent to the devices that transmit data packets to it.

The use of a simplified header format for transferring and receiving data packets and a system that can communicate using the simplified format is provided. The simplified header may simply have basic information pertaining to the data being sent, such as size, sequence of data if transferred among a number of packets, destination address, identification of the communication interface, or different combinations and permutations of such information. A packet may be sent with simply a destination address and accompanying data. In using the simplified format, less memory capacity is required of the wireless device as well as less processing capacity to prepare and send the data packets. The interface may be configured to communicate with wireless device by receiving data from the wireless device and sending data to the wireless device under a simplified header format, the simplified format being simplified relative to conventional TCP/IP/PPP header format. The interface may include a storage device for storing data and a wireless data transceiver for receiving data packets from and transmitting data packets to the wireless device, where the data packets are configured under the simplified format. Accordingly, the wireless device may include a similar transceiver configured to receive data packets from and transmit data packets to the interface.

According to the invention, the interface may also be configured to communicate with a device connected to a network, such as a computer server, that is configured to send, receive and process data formatted under a second header format that may be different than the simplified format. The interface may act as a central header translator that is configured to receive digital data to and from the wireless device configured under a first header format, then translate the first header format to a second header format. The interface may then send the data configured under a second header format to the computer server. In operation, the device may receive the data transmitted to it by the wireless device and convert it from the first header format to the second header format. The device may then transmit the reformatted data packet to the computer server for processing. The device may then receive the processed data transmitted from the computer server, convert the data packet back to the first header format, then transmit the again reformatted data packet back to the wireless device.

The invention may include the utilization of dedicated processors, webservers configured to receive and route browser requests, application servers, state servers and other types of computer processors. These devices may be configured to communicate amongst each other and may be connected to one or more networks, including a Local Area Network (LAN), an intranet and the Internet. These networks may also include the use of wireless as well as wire line connections in order to communicate. However, it will be appreciated by those skilled in the art that such implementations of devices and systems are but few illustrations of the utility of the invention, and that the invention may have greater applicability and utility in many other applications where efficient routing and processing of data within one or more networks is involved. Equivalent structures embodying the invention could be configured for such applications without diverting from the spirit and scope of the invention. Although the embodiments described and illustrated herein are in the context of devices and systems for exchanging data among users of a computer system or network and users of wireless devices, the invention extends to other applications where similar features are useful. The invention may include personal computers, application servers, state servers or Internet webservers that are designed and implemented on a computer and may be connected to a network for communication with other computers to practice the invention. A system configured to operate according to the invention may include a plurality of personal computers and wireless devices connected to the Internet via individual modems or other communication means such as wireless communications.

The invention may also involve a number of functions to be performed by a computer processor, such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. In devices such as wireless devices, it is important that processors are physically small enough to help keep the wireless device itself small, yet powerful enough to be able to perform the tasks required to make the wireless device useful for sending, receiving and using data. It is these goals that a device embodying the invention may achieve.

The software code utilized in the wireless devices and other devices utilizing the invention may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention, which is defined by the appended claims.

Within the different types of devices, such as specialized computer servers and wireless devices, that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, nor any commonly used protocol for storing and retrieving information to and from these memory devices respectively. In devices such as wireless devices, it is important that such memory devices are physically small enough to help keep the wireless device itself small, yet contain enough storage space required to make the wireless device useful for sending, receiving and using data. It is these goals that a device embodying the invention may achieve.

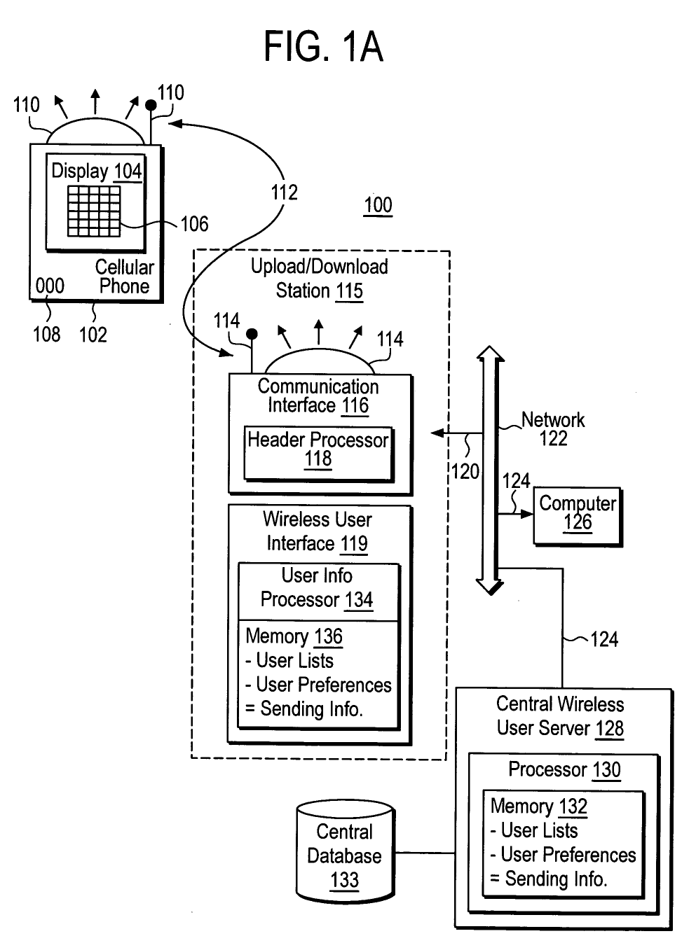

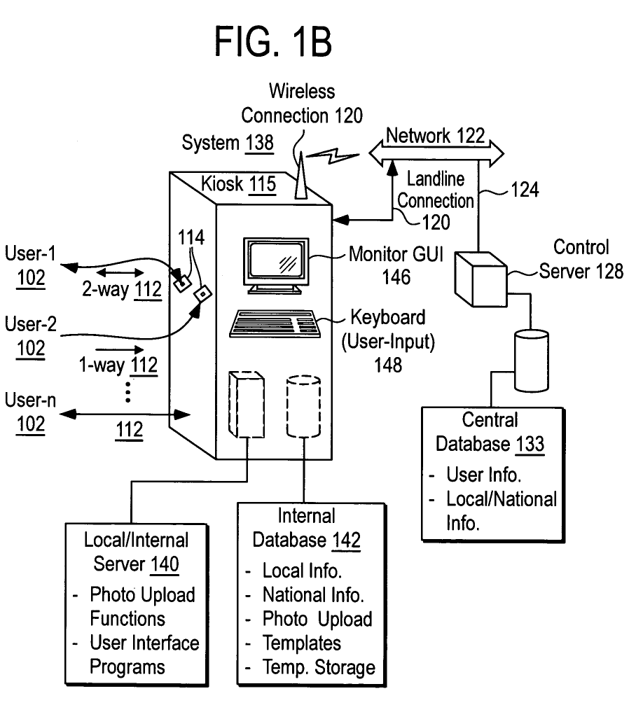

Referring to FIG. 1A, a block diagram of a system having a device configured to enable communication between a wireless device such as a wireless device or cellular phone and a device connected to a network according to the invention is illustrated, in this embodiment a computer server connected to a network such as the Internet. The wireless device 102 includes graphical user interface (GUI) 104 for displaying content 106 to a user. The wireless device may also include manual control switches or knobs 108 for inputting data into the wireless device, but may also be configured with a touch-sensitive screen or other type of data input mechanism for inputting data into the wireless device. The wireless device may also include means for transmitting and receiving data such as an antenna 110 connected to a transceiver (not shown in FIG. 1). Such an antenna may be internal to the device, not visible to a user during normal use. The transceiver may operate as a laser light device, a radio frequency (RF) device, or other type of communication mechanism configured to send and receive data between the wireless device and some destination. The primary purpose of such a device is to provide a portable hand-held device for sending and receiving data between the wireless device and another remote device.

The wireless device may be configured to communicate via a signal 112 with a similar transceiver connected to an antenna 114, which is connected to communication interface 116. The interface transceiver may be configured to operate in the same manner as the wireless device's transceiver. One purpose of the communication device is to provide a mechanism for enabling efficient and improved communication between the wireless device and another device. This is accomplished by reducing the amount of data sent by and received from the wireless device as well as the computations required for such data transactions in the normal use and operation of the wireless device. The communication interface may include a header processor 118 that is configured to manage header information that is transmitted between the wireless device and the communication interface.

On method for communication is by use of the transmission of data packets using the Blue Tooth (BT) protocol. Infrared (IR) transmissions BT are similar that they send and receive user data between cellphone an interface, such as a kiosk configured according to the invention. Different data protocols may be used to perform the transmission, and the invention is not limited to any particular protocol. For example, neither BT or IR is not limited to or exclusively configured to use TCP/IP/PPP or any other high level protocol, such as any particular header protocols in particular. Also, the OBEX protocol runs on top of or in conjunction with both IR and BT. In other words, if the OBEX standard is used, the protocol any particular cell phone uses to beam photos to a computer or wireless device, whether you use IR or BT, is OBEX. Thus, TCP/IP/PPP is one way to operate, a simplified header transmission with IR is another way, and BT is yet another way. As an example, if a user uploaded data using BT or IR, a server can simply forward the uploaded information. This is independent of the IR protocol, such as a simplified header sent via IR. The invention is directed to a system and method for uploading photos (regardless of protocol), processing the photo data to create an email attachment, forwarding the attachment to a predetermined email address, and possibly performing other related functions.

Still referring to FIG. 1A, the communication interface 116 may be configured to communicate through a communication channel 120 with a network 122. The communication channel may be a telephone landline, an Ethernet connection, or any number of communication mechanisms, whether constructed with electronic hardware or some type of wireless application. The Network may be a LAN, an intranet, the Internet, or some other type of mechanism that allows computers and other data processing devices to communicate amongst themselves. The network may also communicate via a second communication channel 124 with a computer 126. This allows a means for the communication interface to communicate with the computer.

The communication interface may be an upload/download station 115 that may further include a wireless user interface 119 that includes photo upload information processes. The interface may include a user information processor 134 with user lists, configured to receive and otherwise utilize user information such as user names, preferences, sending information, and other information.

The network may further communicate with a central wireless user server 128, that is configured with a processor 130 to retrieve and use various user information. The information may be stored in memory 132 having user lists, preferences, sending information, and other information. Sending information may include email addresses and other destination addresses to where data and content, such as photo data, can be transmitted. According to one embodiment of the invention, this can be done automatically.

In operation, the wireless device 102 may process data, convert the data into a signal 112 and transmit the signal to the communication device 116. The data is sent in separate packets, which may be of uniform or varying size. These packets may include a header having a predetermined format that is a specialized format configured to optimize the data transfer. The packet may also be a Blue Tooth configured data packet. The communication device may then convert the header format of the received data to a conventional TCP/IP header. This allows the data to be transferred along conventional channels, such as the network 122, to conventional devices, such as computer 126. The computer can then process the data and then store the data or transmit the data to another location. For example, it may provide a mobile phone user the ability to upload photo data, which can be automatically transmitted to a remote location, such as an email address.

A computer on the network may also return data along the reverse path back to the wireless device. For example, local information may be transmitted to the wireless device, if so configured, to provide local information for use by the wireless user.

Referring to FIG. 1B, an example of a system 138 embodying the invention is illustrated. The wireless devices 102 illustrated here are mobile telephones, User-1, User-2 . . . and User-n respectively, and indefinite amount of users having access to the upload/download station, illustrated as a kiosk 115 here. Each of the signals 112 may be two way, one way, or a combination that is configured to enable a user to upload data to and optionally download data from the kiosk at receiving point 114, which may be an antenna, an infrared (IR) receiving unit, Blue Tooth receiving unit, or other means to receive a signal from the mobile phone. The kiosk further includes a local internal server configured to host photo upload functions, content upload and download functions, and other user interface programs to help enable a user to interact electronically with the kiosk. The kiosk may further include a database 142 configured to store local information that may be downloaded to a user's wireless device, such as local events, menus, maps and other useful local information. The database may further include national and international information for downloading national information such as travel information, related geographical sites, and other useful national or international information.

The database may further include photo upload information. The photo upload information is tied to include user information to associate the uploaded data with the user device that uploaded it. It may be preprogrammed into the system, whereby the user simply needs to upload photo data, and the system automatically associates the uploaded data and corresponding user identification (such as a cellular phone number of the mobile phone, an interned identification, or other identification information). In operation, this allows any mobile phone user to take photos, upload the photo data with its associated user ID, and automatically process the photo data in a manner that is useful to the user. In this application, the communication signal 112 can be one way, as in an upload signal. In this application, the mobile or cellular telephone is configured to upload data, such as photo data, to an antenna or IR receiver on the kiosk. According to the invention, such a single-step process allows a user to upload a photo taken with a mobile phone, where the data is received at the receiving point 114. The kiosk operations may the take over, automatically processing the photo data by storing the data. Then, the system may transmit the photo data via a wireless connection 120 or landline connection 120 to other locations via network 122, such as central server 128, and stored in central database 133. The central database and associated server may keep a central base of user information, preferences, templates, and local, national and international information.

In one embodiment, a user can upload a photo data file, and the kiosk can store the photo data, then transmit the photo data to a remote storage location. In one specific example, an email with a photo attachment can be transmitted to the email address, or multiple addresses. The user can configure its user preferences to transmit an email to the user, or to multiple other email addresses, such as family, friends, business associates, and other entities. This can be done automatically once a user sets up the user preferences.

Setting up the user preferences can be done via the internet prior to uploading the photo data. It can also be performed at the kiosk itself using the monitor (graphical user interface (GUI)) and keyboard 148 or other device for receiving user input, such as touch screen, voice activated receiving device, or other device for receiving user information. A user can login at the kiosk, set or reset user identifications and preferences, and then proceed to upload photo data.

In another embodiment, an application may be located in the user wireless device itself, configuring it to interact with the kiosk for uploading data. This would use a two way communication such as that illustrated with User-1, where the user device identifies itself, uploads the user information receives an acknowledgement from the kiosk, then uploads the data. In this embodiment, a user can go to any kiosk 115 and upload data without the need to preload user identification or preference information. It can be done entirely from the user device.

The invention obviates the use of a cellular phone system to upload photos. It further obviates the downloading of information if an interface or kiosk is so configured. One step is the transfer of data from the wireless device to the communication interface. As discussed in the background, conventional devices communicate using the conventional protocol, which requires a large amount of processing prior to transmitting data. Cellular telephone services, used by mobile phones, also require complex telecommunication protocols including dialing up the system, transmitting cellular phone signals and other processes that take time, resources, cost money in air time and fees, and are generally cumbersome for a user who simply wants to upload photograph information, for example, or download local or other related information. This processing also generates more data that must be transmitted along with the large header as well as the actual data. The communication interface takes this burden off of the wireless device by directly communicating with the device to transmit data. In one embodiment,

In another embodiment, the interface provides processing of photo and other related data, which can then be processed or sent to other devices in remote locations, such as the computer 126. At this location, the computer is able to perform complex operations on the data that may be overly burdensome for the wireless device. For example, a user of a wireless device may want financial projections on a transaction. The user could send the basic information to the computer via the communication interface. The computer, having extensive processing power, could perform the complex operations and then transmit the result data back to the wireless device via the communication interface for use by the wireless device's user. According to the invention, these new features provided by the system effectively give virtually limitless remote processing power to the wireless device, and actually reduce the processing and data storage burden on the wireless device at the same time.

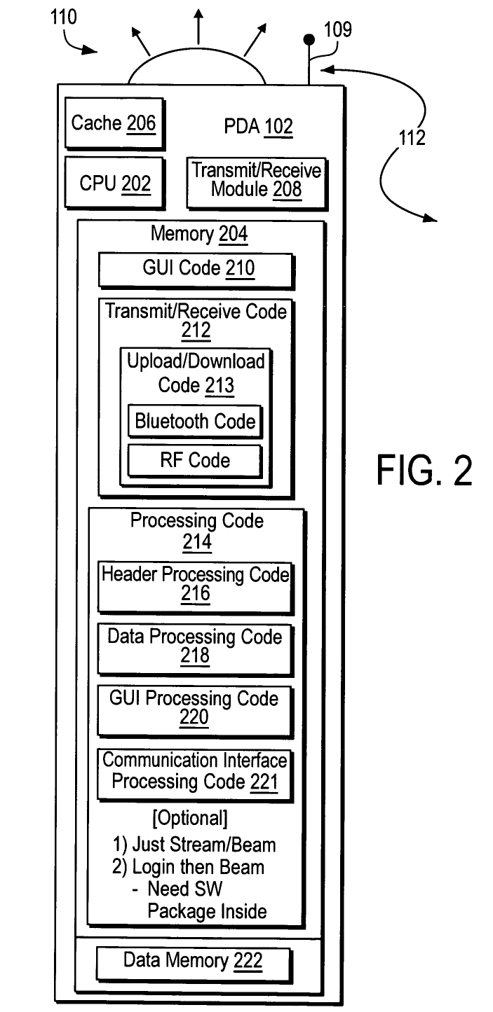

In order to understand the operation of the invention, it is useful to understand the components in more detail. Referring first to FIG. 2, a more detailed illustration of a wireless device, such as a mobile phone or wireless device, 102 is shown. The wireless device typically includes a central processing unit (CPU) 202 that is configured to execute software commands and perform wireless device functions according to the command instructions that may be received from an outside source. These commands may be stored in main memory 204 or cache memory 206. Such functions may include the transmission and reception of data, graphical user interface operations, data processing operations, data security functions, and other functions that may be related to the operation and use of a wireless device. The wireless device typically includes some type of transmit/receive module 208, which may be a transceiver that performs both sending and receiving operations, or separate components for transmitting and receiving data. The module may be connected to an antenna 110 for sending and receiving electronic signals 112.

The wireless device may include a main memory 204 having software code and data stored therein. The software code may be executed by the CPU 202, and may govern the operations and functions of the wireless device. The wireless device may also include cache memory 206 for storing data frequently used by the CPU. In some applications, the wireless device may be configured to store software from the main memory into the cache memory in order to give the CPU easier access to the data for execution. Graphical user interface code 210 may be executed by the CPU to control the wireless device's display 104 (FIG. 1). The code used would likely be unique to the application used for the graphical display, such as a light emitting diode (LED) display, a quartz display, or other type of display. Many types and implementations of displays are well known to those skilled in the art of wireless device design as well as other similar technologies. Transmit and receive code 212 may also be included in the wireless device main memory. Upon execution by the CPU, the transmit and receive code enables the CPU to cause the wireless device to transmit and receive data with the transmit and receive module 208. The memory may include upload and download code 213, including upload code for enabling the uploading of data from a wireless device, and may further include optional download code for downloading data to the user device. The code may include Blue Tooth standard code, radio frequency (RF) code, or other communication code. The memory may further include processing code 214 for processing instructions and data related to processing headers, data, GUI instructions and data, and other instructions.

The processing code may include header processing code 216 configured to change headers among different formats according to the invention. As discussed above, the invention provides a method and apparatus for optimized transmission of data between the wireless device and the Internet obviating the need for a cellular phone system to transmit data. The wireless device simply sends data packets having reduced headers in order to reduce the computation needed to prepare and send the data. The data is simply sent with minimal information. The header information may include the IP addresses of the wireless device and the destination device for identifying the source and destination of the information. The header may also include the file name, the file size, the sequence of the data packet in relation to other data that has been sent, and other information related to the data, of different combinations and permutations of such information. Of course, the packet may also include the data itself, which may be referred to as payload data.

The header accompanying data within a packet may be configured according to a standard protocol such as the IRDA Object Exchange Standard, or IrOBEX, developed by the Infrared Data Association™, a copy of which is attached. The invention, however, is not limited this protocol, but extends to other configurations that allow a data packet to be configured with limited header information, or even no header information. Such a data packet may include the minimal amount of information that is required to transmit data such as photo data from the wireless device to the communication interface, such as the name of the file being transferred and the beginning and end of the data. Importantly though, according to the invention, the protocol is irrelevant, thus not limiting to the invention.

Still referring to FIG. 2, the wireless device may also include data processing code 218 stored in its main memory 204 for performing the processing of data within the wireless device when the CPU executes the code. According to the invention, many data processing functions may be performed remotely, sparing the wireless device of the processing burden. This allows the wireless device to run more efficiently and require less powerful processing circuitry. The wireless device memory may also include GUI processing code 220 for performing general GUI functions when executed by the CPU. Communication interface processing code 221 may also optionally be included in the wireless device, where the application calls for an internal program for uploading and downloading information and content between the wireless device and the kiosk (115 FIG. 1B), as discussed above. The main memory may also include data memory 222 for storing data to be used or transmitted by the wireless device.

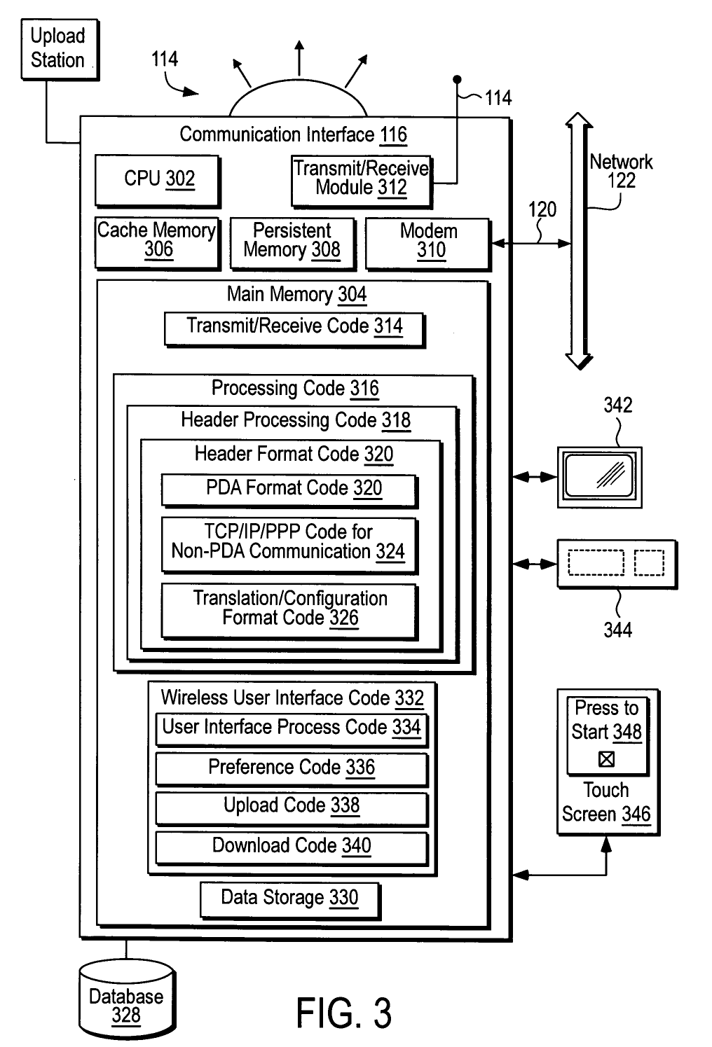

Referring to FIG. 3, further details of the communications interface 116 are shown. The interface may include a CPU 302 configured to execute software code stored in main memory 304 for performing internal operations of the interface. Optional cache memory 306 and persistent memory 308 may also be included in the interface to provide alternative storage locations to optimize access to data by the CPU. The interface may also include modem 310 that allows the interface to communicate with network 122 via communication link 120 as discussed above. This enables communication with other devices on the network such as computer 126 of FIG. 1. Transmit and receive module 312 may also be included for facilitating communication between the interface and the wireless device, and the module may be connected to antenna 114. The module may be a transceiver, performing both transmit and receive functions, or the two functions may be divided into two separate modules. The transmission module may be a radio frequency module, configured to send and receive RF signals. The module may also be an infrared LAN (local area network) access point (LAP) for receiving and sending infrared signals when communicating with a similarly equipped and configured wireless device. The transmission module may be a BT configured protocol, or other protocol that enables the uploading, and possibly downloading of data. The invention is not limited to a particular type of interface between the wireless device and the communication interface.

The interface includes a main memory 304 for providing main storage of data and software code required for the operation of the interface. Transmit code 314 may be included to allow the interface to perform transmit and receive functions when the code is executed by the CPU. According to the invention, the code can be designed to configure the interface to send and transmit data configured under any protocol.

The interface may also include processing code 316, which, according to the invention, configures the CPU to perform data processing and instruction execution when the CPU executes the code. The code may include header processing code 318. The processing code includes executable software code for performing the header format configurations. These configurations may be used in facilitating communication between the wireless device and the computer, and for transmitting uploaded data to an application server connected either directly to the interface, or via a network such as the Internet. Header format code 320 is configured to process headers of data packets by configuring them with the proper format according to the intended destination of the data packet.

For example, a data packet originating from the wireless device and destined for the computer may be uploading photo data for further transmission to a remote location. The CPU may reconfigure this data packet when it executes the wireless device format code 322. This code may allow the CPU to separate the data from the header so that it can be reconfigured for the transmission. The translation and configuration format code 326 may then translate the header information pertaining to the data transmission from one format to another format. The reconfigured data packet can then be stored in data storage 330 or database 328, then retransmitted to the computer using the transmit and receive code 314. If communicating with another wireless device, the communication interface may retransmit a data packet to another wireless device. Or, if the packet is destined for other wireless devices that are not so configured, it may transmit data using a conventional protocol, such as using a TCP/IP/PPP header. This would make the communication device universally compatible with multiple communication devices.

The communication interface 116 may include wireless user interface code 332 for enabling the uploading and optional downloading of data and related content between the communication interface and the wireless device. The interface code may include user interface process code 334 for processing data sent and received with a wireless device. It may further include preference code 336 that defines the user preferences corresponding with a user device. It may further include upload code 338 and download code 340 that corresponds with the upload/download operations of the user device.

The communication interface or kiosk may further include a screen 342 and keyboard 344 that allow a user to acquire a membership on site of the upload location. It may further include a touch-screen 346 having input areas 348 to help a user acquire and account. Either may further allow a user to inquire into or otherwise manage an upload or download service account at an upload location.

The computer, 126, may be any type of data processing device such as a personal computer, wireless data communication device, or any other device that communicates by sending data packets configured with headers having different formats, such as a TCP/IP format. According to the invention, a wireless device is able to communicate with such computers via the communication interface without having to deal with any particular format, such as TCP/IP and TCP/IP/PPP header format operations.

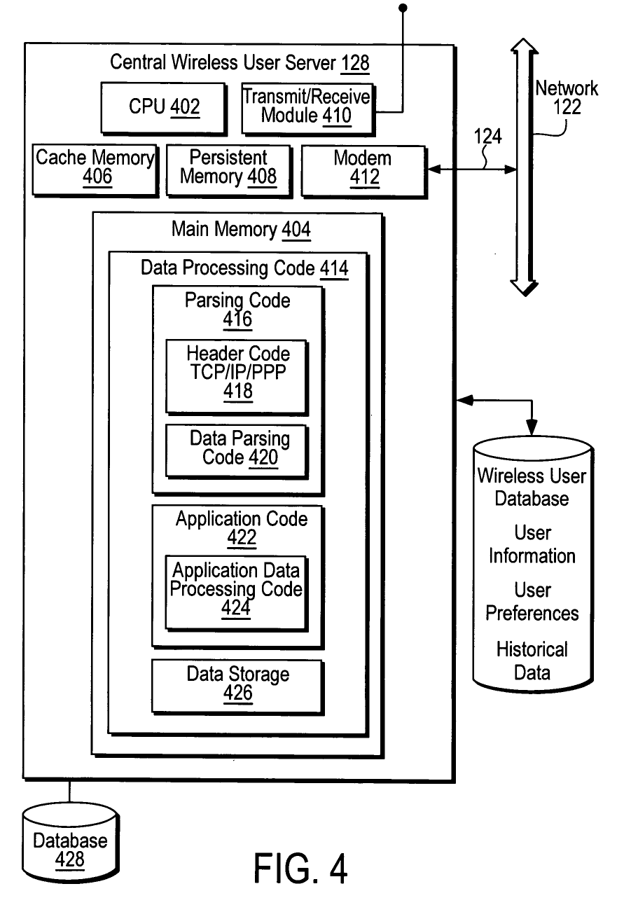

Referring to FIG. 4, a more detailed block diagram of a computer in an embodiment of a central wireless server 128 is shown. The computer may include a CPU 402 configured to perform standard processing operations of the computer when it executes software stored in main memory 404. The computer may also include cache memory 406 and persistent memory 408 for providing more efficient access to data and command instructions to the CPU for execution.

In an alternative embodiment of the invention, the computer may include the functions of the communication interface 116. The computer would then include substantially all of the processing code 316 and transmit and receive code 314, FIG. 3. The computer would then need a transmit and receive module 410 for communicating with the wireless device in the same manner as the communication device 116 does with its transmit and receive module 312. In such a configuration, the communication interface is built in to the computer, obviating the need for a separate device.

The computer may further include data processing code 414 that includes code that configures the CPU to perform data processing tasks. The code includes parsing code 416. The parsing code may cause the data such as photo data to be parsed out from a data packet when the CPU processes the received data from the wireless device. Data may also be parsed out from a data packet by executing the data parsing code 420 with the CPU. Data may be separated from the an associated header, and the computer may store the data in data storage 426 and process the data by executing the application data processing code of application code 422.

The application code may be code configured under any one of a number of applications wherein data may be used, processed or otherwise consumed. These applications may be used as remote operations to the wireless device, giving it extra processing power that can be performed by the computer. For example, the user of a wireless device may wish to attach and send a document or other large data attachment to an email for transmission via the Internet. The wireless device being limited in size and, consequently, limited in memory and data processing capacity, it would be a large burden for it to have the document stored and processed in the wireless device. According to the invention, in response to a request sent from the wireless device, a document stored on the computer is capable of being attached to an email and transmitted to an email recipient. The capacity of the computer may be utilized in numerous ways to offer expanded memory and processing capacity to the wireless device remotely. This capacity may also be provided to the wireless device by the communication interface 116. The interface may be equipped in the same manner as the computer as described herein to provide remote processing and data storage functions.

The computer may also include a database 428 containing data for use by the computer 126. According to the invention, the wireless device may be able to access the database attached to the computer by sending data packets containing instructions to do so. Using this technique, the wireless device is able to perform processing and transmission of data that would normally be burdensome to the wireless device performing these tasks by itself. The central server may be an application server configured to enable the functions of automatically processing data sent by a wireless user. The system, generally, is for use in a system having a communication interface for communication between a wireless device and the communication interface, the communication interface being configured to communicate with other devices communicating with a network and configured to facilitate data communication between the wireless device and other devices connected to the network to retrieve and otherwise consume information by receiving a data signal from a wireless device that is configured to establish a communication link with the interface. The application server would be configured to receive uploaded user data from an interface, the application server including a processor configured to automatically process the uploaded user data according to predetermined user preferences. This automatic process is storing the uploaded data, such as photo data. The process may further include automatically forwarding the data to a predetermined destination, such as an email address.

The system further includes a user interface, which may be embodied as an upload station, kiosk or other data receiving means that is configured to establish a user identification (ID) and to establish user preferences directed to defining predetermined operations to be performed at the request of a user. The application server may be co-located or otherwise proximal to the interface, and may include parsing code configured to parse out the user ID from a data received from a use and further include application code configured to retrieve predetermined user preferences.

The application server may include application data processing code configured to create an email message, attached uploaded data to the email message, and to transmit the email message to at least one predetermined email address according to the user preferences. The applicant code may further be configured to send information requested by a user according to the user location. The uploaded data received by the application server includes location information pertaining to a user location, the application data processing code, retrieving localized information according to the user location and forwarding the location related data to the wireless device.

An application server may further comprise statistics code for generating statistics report to system administrator

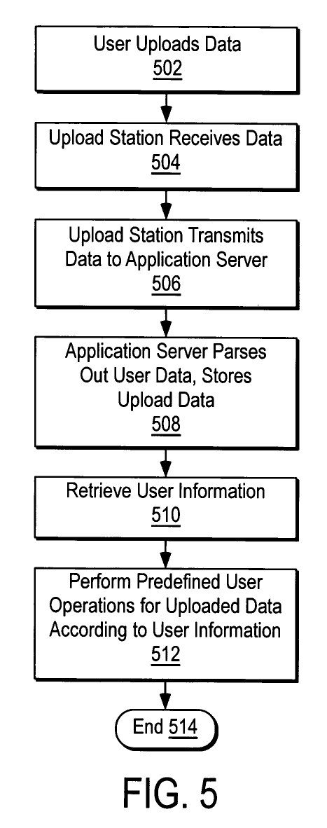

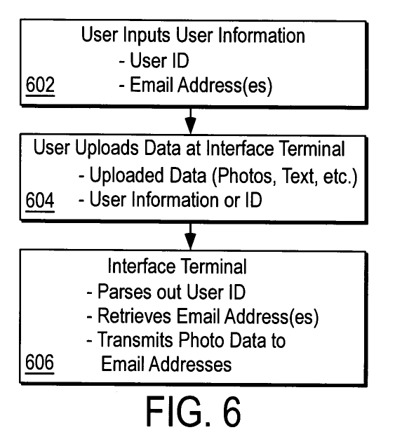

To better explain the operation of one embodiment of the invention, reference is made to FIGS. 5 and 6.

Referring to FIG. 5, and in FIGS. 5-8, various embodiments of the operations of the system are illustrated according to the invention. Referring first to FIG. 5, one embodiment of an operation is illustrated. In Step 502, a user uploads data, such as photo data, text data or other types of data the user wishes to upload. In Step 504, the upload station receives the data. In Step 506, the upload station transmits the data to an application server. In Step 508, the application server parses out user data and stores the uploaded data. In Step 510, the application server uses the user data to retrieve the user information. With this information, in Step 512, the application server performs predefined user operations for uploaded data according to the user information. The operation ends in Step 514.

Generally, the operation of such a system depends upon a user's information and related data that is input by the user, giving direction to the system for handling the user's data. For example, if a user wished to upload photo data, the user would input a userid, destination addresses, such as email addresses, and other information related to uploading operations. As an example of uploading operations, these may include converting the photo information into a PDF file, a JPEG file, or other type of photo application operation related to uploading and attaching photos to an email. Other embodiments discussed below will further illustrate the advantages of the special features of the Novel system as it relates to real life user operations.

Referring to FIG. 6, a method 600 is illustrated that allows a user to upload information in a single operation and configure the system to perform automatic operations to the uploaded data. In Step 602, a user inputs user information, such as a userid, email addresses, and other information related to the user. Many applications existing are for retrieving, storing and generally managing such user information. This information may be stored in a central application server, a local interface terminal where the user initially inputs user information, or other location where such user information can be conveniently stored for use by the system in performing the user-specified operations. In Step 604, a user uploads data at the interface terminal that would include uploaded data, such as photos, text messages or other information. The user would further upload user information such as userid so that the system may identify the user with the uploaded data. For example, a user may use a cellular phone that is configured to take photos and transmit photo data using IR and Bluetooth protocols. An interface terminal may be located in a central location where a user may have access, and the user can go to the location of the interface terminal to upload the desired data. At the interface terminal, the interface terminal may be self-sufficient in its operations and would be able to parse out userids, retrieve email addresses according to the userids, and transmit photo data to predetermined email addresses for the user in Step 606. Such an interface terminal may include a keyboard and a screen, possibly a touchscreen without a keyboard, which allows a user to input the user information into the system, upload the data, and allow the unique system to automatically transmit the data to predetermined locations, such as emailing photos to predetermined email addresses. There can be one or more email addresses, which would allow a user to email photos to multiple locations, such as family members while they are on vacation, and then continue to take more photos. Once these photos are transmitted, there is no need to further store them on the cellular phone memory, so a user may then erase the photo data, allowing for more data storage space for more photos.

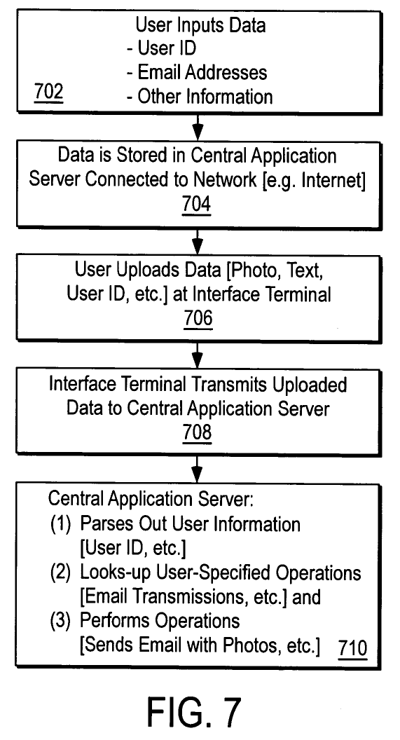

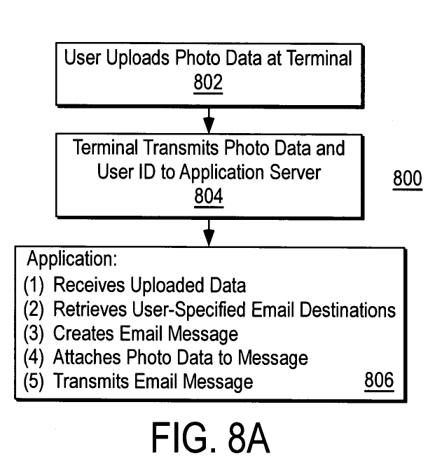

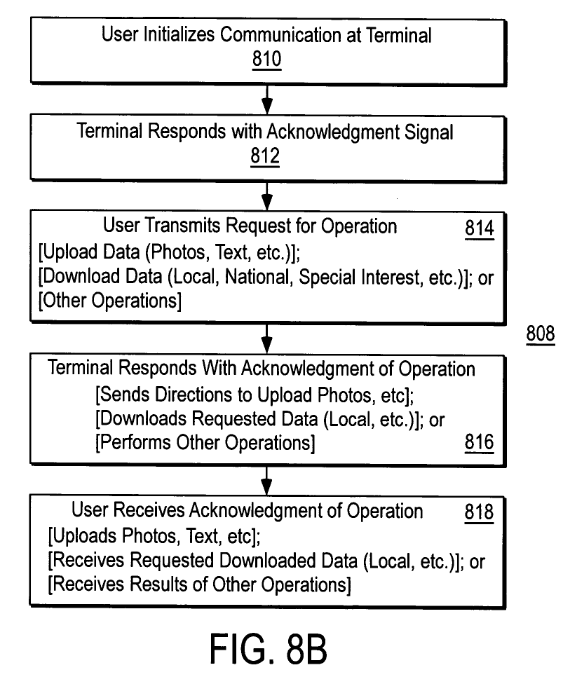

Referring to FIG. 7, another embodiment of the invention 700 illustrates a method for essentially storing user information and performing central operations on data uploaded by a user. In step 702, a user inputs data including a userid, predetermined email addresses, and other information related to operations of the system by the user. In Step 704, the data is stored in a central application server connected to a network, such as the internet. Once this is set up, a user may take advantage of the unique operations of the system by uploading data and having the data processed by the system automatically according to the user information. In Step 706, a user may upload data at a remote location, such as photos, text, related userid and other information, perhaps at an interface terminal. The interface terminal may then automatically transmit the uploaded data to the central applications server in Step 708, where the system operations are performed. At the central applications server, the server may then parse out user information such as userid and other information. The application server may then look up user specified user-specified operations, such email transmissions, special data storage instructions, or other operations specified by the system. The central application server may then perform these operations automatically according to the user preferences. For example, when the user inputs date in Step 702, the user may have specified certain operations to be performed when the user uploads data. For example, a user may specify that when photo data is uploaded at an interface terminal, the photo upload data is stored in a remote location, such as the application server, for future use. A user may further specify that the photo data is packaged in a certain manner, such as in a PDF, JPEG or other type of photo file, and emailed to a particular email address or to multiple email addresses. Other operations may be performed as well. For example, a user may set preferences to perform special operations on uploaded data, such as special security packaging that requires a userid and password in order to open. Other preferences are possible and the invention is not limited to any such particular preference. Referring to FIGS. 8a and 8b, two different types of systems are illustrated, one where the user has a single operation when uploading data and automatic operations are performed on that data, and the other, illustrated in FIG. 8b, where there is interaction between the user and the interface terminal in uploading data. In Step 802, a user may upload photo data at a terminal. In Step 804, the terminal automatically transmits the data and userid to the application server. In Step 806, once the application receives the uploaded data, the application server retrieves the user-specified email destinations, creates an email message, attaches photo data to the message, and then transmits the email message to the email address. This application provides a single upload operation where a user can approach an interface terminal, and initiate a single operation, such as an upload operation, and the combination of the interface terminal and application server can automatically perform operations on the uploaded photo data. Referring to FIG. 8b, a more interactive operation is illustrated. In Step 810, a user initializes communication at a terminal. In Step 812, the terminal responds with an acknowledgement signal, indicating an open communication line to the user. For example, a cellular phone, PDA or other wireless device may be configured with an internal software application that allows the interaction between the user and the terminal. In Step 814, the user transmits a request for an operation. For example, the user may request the upload of data such as photos, text or other information. The user may further request to download data, such as local, national or special interest information related to the remote location where the user interface is located. The user may also wish to download local, national or international news for the user's review. Once the request for operation is transmitted in Step 814, the terminal responds with an acknowledgment of the operation after receiving it in Step 816. In response, the terminal may send directions to upload photos so that a user may perform photo upload operations. Furthermore, the terminal may download requested data by a user, such as local, national or other news or information. The terminal may respond by performing other operations according to the user's request. In Step 818, the user receives acknowledgment of the operation, and responds accordingly. For example, this may be the point where a user uploads photo data or other information for processing by the system as discussed above. The user may also receive information from the interface terminal such the requested downloaded data, such as local, national or other related data. The user may also receive results of other operations.

In another embodiment, the invention provides a useful device and method to use a hand held wireless device, such as a cellular phone, to upload and download information locally without needing to access the cellular telephone network. Though cellular phone service providers offer different products and services, their services are seldom relevant or adaptable to specialized wireless device applications. Also, regardless of the capacity of the wireless device, access to a cellular network is limited to the range of the cellular phone system. In most situations, access and support for particular applications can be lacking.

Cellular networks cost money to use, and comparing with wireless or infrared LAN, they are less limited in access of broader areas to achieve greater mobile coverage. On the other hand, a venue or a store cannot deliver location specific information to the cell phone through cellular network while the phone user is visiting the store. The cellular network cannot pinpoint to an actual location of the cell phone unless some manual procedures are performed by a user. For example, a user would need to identify and access a particular application program on the cell phone, connect to a network, and send and receive information. The “location” can mean for example a fast food restaurant on xyz street of a city, a store in a mall, or gate xyz of a terminal of an airport. In many locations, access using the cellular phone system can be burdensome to a user. For example, if a user is in a fast food restaurant, the daily menu, specials, coupons, and possibly ordering information may be available to a wireless user for convenience. A user may be able to avoid waiting in line by ordering and even paying for a food order using the wireless device. Unless access and support are available, the user is left to wait in line. Also, if access is burdensome or time consuming, the user will not bother using this convenient service, losing out on its benefits.

Furthermore, support for an application in a particular and unique location can be unavailable given a user's cellular phone provider and whatever services are provided. A business may need a robust system to provide services. Such a system may need weekly, daily, hourly or real time updates. The system may need maintenance by people familiar with the business, and would therefore need to be accessed, updated and maintained outside the cellular phone network. This would be difficult for a cellular service provider to provide given conventional systems available.

If, however, the restaurant has a system available that is configured according to the invention, such service is possible without the need of a cellular network. Information can be beamed to and from the wireless device, or cellular phone configured as a wireless device. The information exchanged could be local in nature, and the transmission can be performed with local hardware, again, without the need of the cellular network. Transmissions can also be shared with a local server, where transmissions from a user can be processed. They can also be shared with other devices via networks, such as the Internet, where application servers are located and maintained remotely from the contact locations. An application server can be configured to communicate with an interface, where the server processes transmissions occurring between wireless devices and the interface, enabling convenient local services for wireless users.

In many conventional wireless or mobile devices, cellular phones, wireless devices and other devices, the web browser used to access the Internet typically uses HTTP protocol to access the Internet. Conventional IR and/or Bluetooth equipped wireless device or cell phone support the OBEX protocol. The invention defines algorithms for mobile devices to access the Internet using the OBEX protocol instead of the cellular network to upload information from a wireless device and download to a device.

In one application of the invention, local information can be uploaded and downloaded from a cellular telephone configured to transmit and receive localized information that pertains to a location where a user operates. For example, a user may bring a wireless device, or a cellular phone operating as a wireless device, to a fast food restaurant and beam up menu information, coupons, daily specials, and other information. This information can be viewed by a user before an order is made, and can be interactive in nature. It is also possible for further features, such as questions sent and answers received, actual orders made, updating information, and other features. A remote or local server is utilized to maintain relevant information that is relevant to the location. When this user brings the same wireless device to a store next or near to this fast food restaurant, the wireless device will receive localized information that pertains to the store according to this invention.

As still further background, all of the IR and Bluetooth enabled cell phones support IrOBEX, which is a protocol developed by IrDA (www.irda.org) and later adopted by Bluetooth. The design of the protocol is to enable easy object exchange between 2 IR or Bluetooth devices, where the object could be a business card, calendar and so on. The IrMC specification defines a group of objects that are supported using the OBEX protocol, vCard for business card and vCalendar for calendar for example.

[Local functions related to downloading local information.]In one embodiment, the invention provides an algorithm to define a way for one application to identify the location where the application is running.

For example, assuming ABCD is a nation wide chain store, each of the local ABCD store may offer a coupon to attract customers. The coupon, containing information related to the item on sale, can be determined by the local store, thus different local stores could offer different coupons. A mobile device may have installed a “Get Coupon” application from ABCD's main web site. And, all the local ABCD stores may have network connections to ABCD's main application server. At a local store, using conventional approach, the user needs to enter the location of the store or the store's branch number into the “Get Coupon” application so that ABCD's main application server can send out the correct coupon to the user. Finding and entering the correct store location or branch number could be very inconvenient for the user. This algorithm solves the problem of how the “Get Coupon” application determines where the user is located and how to retrieve the correct coupon of the local store. As a further extension, the user may go to a non-ABCD store, for example a XYZ store, without having to be aware of the user's location, i.e., the user will not need to worry about determining whether “now, I am in XYZ store and I have to launch an application that associates with XYZ store”. Instead, according to the invention, the user may launch the same “Get Coupon” application used in ABCD store on the mobile device. A system configured according to the invention will find the correct server to seamlessly and almost invisibly provide information localized for this XYZ store. That indicates that the mobile device user will only have to know his/her objective, for example, to get a coupon by the functionality of Get Coupon, where the user is simply concerned with making connection regardless the user's the location. Thus, the URL address in the wireless device can operate as a dummy address that does not necessarily need to match with the user's location.

This algorithm defines that the location and related localized information to be stored in the access point. This localized information is to be sent together with user's request. Referring back to the previous login example, an illustration of this algorithm is best understood by way of example. The localized information “store=ABCD&location=SFO&branch=3940” is stored in the access point. The information says the store is ABCD, location is SFO and branch number is 3940. The user sends out OBEX PUT command to the access point with file name
#http://www.ABCD.com/login.asp
   The access point sees the # sign knowing it should send out a HTTP POST command and it will combine the localized information and send
http://www.ABCD.com/login.asp? store=ABCD&location=SFO&branch=3940 to the application server www.ABCD.com. The program login.asp will be executed by the application server and with the parameters in the URL, the application server knows exactly where the user is at and the correct coupon could then be sent to the user.
   [Is this discussion below relevant in this application, whether it be for Uploading photos or Downloading local information?]

In one embodiment, the invention provides an algorithm to define another way for one application to identify the location where the application server is running. This is useful for uploading localized information, as well as locating a user's application server on which the user's information is centrally located.

In conventional systems, URLs are of two types, absolute and relative. An absolute URL includes all the information needed for accessing a resource. The information in a relative URL is incomplete. A typical client application (e.g. a web browser), must resolve the relative URL before sending out the request for accessing the resource. According to the invention, the client application do not need to resolve the relative URL if the localization is desired. Thus, an algorithm configured according to the invention supports access to localized resources.

If the URL in the OBEX name header contains no server location and/or path information, the default information in the access point is used. The request is then passed to the associated server location.

Different access points may have different default information (URL destination). For example, the access points in store A may have the default information set to “www.company_{—}11.com/branch7”, in store B have “www.company_{—}33.com/branch66”, and in store C have “www.company_{—}11.com/branch23”. Thus, according to the invention, it is not necessary to specify the location of the application server in the header. The actual location of the application server is determined by the access point, therefore, a single client application with the same header in the wireless device can reach different application server determined by the access point in the store. For example,
Header in store A: http:///index.html
Will be translated into http://www.company_{—}11.com/branch7/index.html and
Header in store B: http:///index.html
Will be translated into http://www.company_{—}33.com/branch66/index.html

Thus, utilizing the invention, the localized information is easily found by a user at the location where the user may submit or otherwise consume the coupon. This allows a business to increase customer loyalty by providing them Internet connectivity at a specific location in a manner that enables them to interact for an improved in-store experience and better service overall

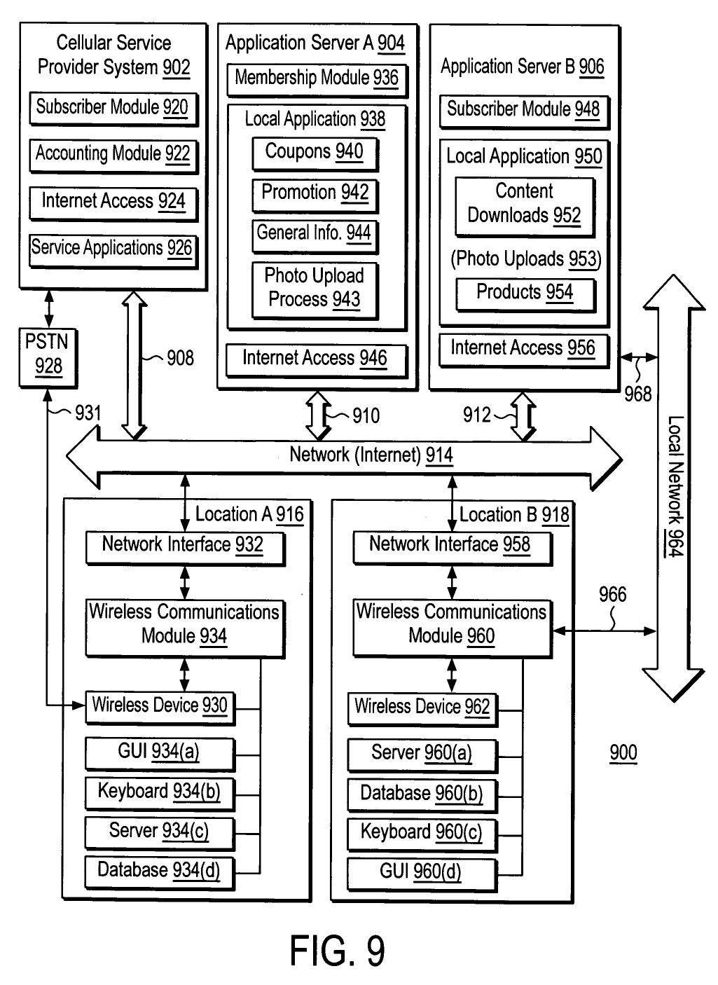

Referring to FIG. 9, an illustration of a system 900 configured according to the invention for providing communication with wireless devices at locations is shown. The system includes servers 902, 904, 906, configured to provide services to a wireless device. Each is configured to communicate via communication lines 908, 910, 912, to a network 914, such as a LAN, the Internet, or other network communication media. Local systems 916 (Location A), 918 (Location B), are configured to communicate with the servers via the network 914 to provide local customer service and other functions as may be appropriate for a local business application. The server 902 is a cellular service provider system that provides service to cellular telephones. The server includes a subscriber module 920 configured to manage subscriber information, including subscriber membership status and related information. An accounting module 922 is included to manage accounting information related to subscribers, such as any fees that are due or paid, any statistical information that may be relevant to membership status or promotional offers, and other accounting related information. An Internet access module 924 is also included to provide access to the Internet as may be appropriate in a particular application. Service application module 926 is included for providing particular services to users via the cellular system. A conventional system would provide services via the PSTN 928 as conventional services. Signals are typically transmitted between the wireless device 930 and the cellular service provider system via cellular media connections 931. As discussed above, conventional cellular services are limited in access and support. According to the invention, if such services were able to users, local access that is specialized and directed to users at specific locations could provide a valuable business service value.

Still referring to FIG. 9, the Location A 916 includes a network interface 932 that is configured to receive signals from wireless communication module (WCM) 934, which receives signals from wireless device 930. In operation, a user of the wireless device can arrive at Location A and communicate a signal to the wireless module to get local information. The signal is transmitted to the application server A 904, where local information is processed and sent to the wireless device for use by the user of wireless device 930. The local information may include coupons 940, promotions 942, general information 944 and photo upload information 943.

The Location A, such as a kiosk, 916, may include network interface 931, and wireless communication module 934, which is he core of the kiosk described above. The kiosk includes a GUI 934(a), a keyboard 934(b), and server 934(c) and local database 934(c).

Similarly, a user can arrive at Location B 918 to retrieve local information that is pertinent to Location B. Application server B includes a subscriber module 948 configured to maintain subscriptions, payment history and other subscriber information relevant to subscribers use of the system at Location B. The local application 950 is configured to service the local wireless device users at Location B. The local application 950 may include a content downloads module 952 configured to enable downloadable content, and products module 954 may be configured to enable downloadable products, such as programs and related data. Internet access module 956 is configured to enable communication with the Internet and connected devices via communication link 912. A network interface 958 connects Wireless Communication Module (WCM) 960 to the network 914, which connects the wireless device 962 to all associated servers and devices. The wireless device may contact WCM 960 to obtain local information, or even products that may be downloaded at that location. The WCM may communicate via the network interface 958 or with local network 964 via communication link 966 to LAN 964. The LAN may then connect to the Application server B 906 via communication link 968. Any of these communication links may be configured with convention media communication links. Server 904 and 905 may reside in the same computer. Location B may also have corresponding kiosk components Server 960(a), database 960(b), keyboard 960(c) and GUI 960(d). These can be used in photo upload operations discussed above.

In general, individual kiosks can operate as the application server that forwards photos to all the predetermined email address. In another embodiment, a central application server centrally stores the user information, such as the predetermined email addresses, user IDs, and other information related to the operation of the system. In such a centralized system, users can log on to the central application server via a network location, such as the Internet, to enter and change user information. For example, a user can enter all email addresses by using a web browser to a well known URL (http;//www.clarinetsys.com for example). The central application server would operate to manage the user information for the system of kiosks.

The user information or user ID may include multiple predetermined destinations. In one embodiment, the when the user upload is received from a terminal interface, such as a kiosk, the destination address may be the email addresses to where the uploaded information is transmitted. If a kiosk is self contained, where it includes an application server configured to perform the operations of the uploading, processing and emailing of the photo data to an email address, then the predetermined destination is the email address. If, however, the kiosk is not central, but is connected to a central application server, then one predetermined address of transmission would be the central application server. This is where the operations are performed. The application server then forwards the content data (photos) as e-mail attachment to predetermined email addresses, these are secondary predetermined destinations in a centralized system. The address of the application server may be included in the user ID when uploaded to the kiosk. The address of the application server may also be ascertained by the kiosk using the user-ID and performing a lookup operations. Thus, in a centralized system, one destination could be the application server and the other is the email address. Likewise, the Kiosk could be the one single central server, which includes the application server.

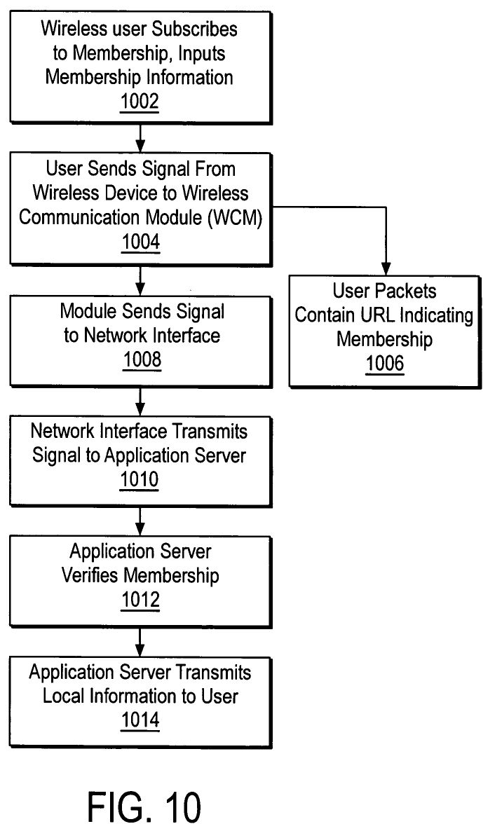

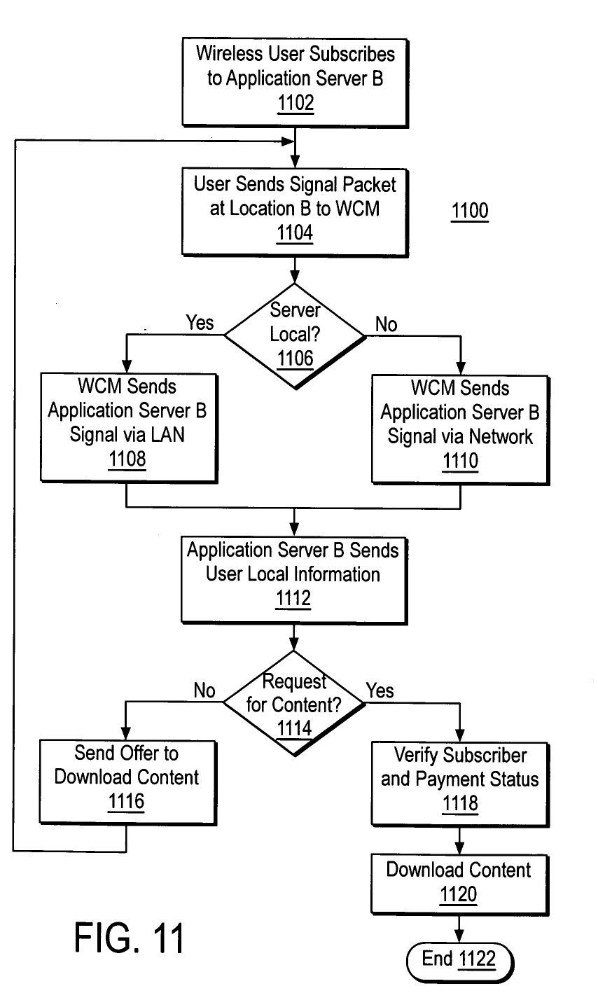

Referring to FIG. 10, a sample method of operation for the inventive method are illustrated. This method illustrates embodiments of the invention and are intended as sample embodiments, not as limitations to the invention or as exclusive examples. Those skilled in the art will understand and agree that other embodiments are possible, given the scope of the invention, which is defined by the appended claims and al equivalents.

Referring to FIG. 10, a process 1000 is illustrated for transmitting local and proximal information to a user of a wireless device. This process may be incorporated in a system configured with the photo upload operations discussed above, or separately. In a first step, 1002, a wireless user subscribes to membership, whether there is a charge or cost for a membership or not, and inputs membership information. This information may be quite simple, such as a name and email address, or it may be more detailed, depending on the application. After the user is registered, the user can access a merchant's system by using a wireless device at the merchant's location. In step 1004, the user sends a signal from a wireless device to wireless communication module at a merchant's location. The signal may be in the form of a packet that contains a URL in step 1006 that indicates membership to the merchant's system. In practice, the URL may relate to multiple merchants that subscribe to the system, or may have certain blocks of merchants in different industries and product or service businesses that offer wireless local information to customers. In response to the packet being sent, the module sends the signal to a network interface in step 1008. The network interface then transmits a signal to an application server in step 1010, where the signal send from the user's wireless device is processed. In an optional step, the application server then verifies the membership in step 1012, and the process is almost complete. The application server transmits local and proximal information to the user in step 1014.

The invention is directed to a method and apparatus for efficiently exchanging local information according to commands via a URL between a wireless device, such as a cellular telephone or wireless device, and a data interface configured to receive such data. The interface may be a conventional data processing device such as a computer server. In one embodiment, a communication interface is configured to exchange digital data configured with a first header format such as OBEX. The communication interface is also configured to exchange digital data configured with a second header format with a device such as computer. Although this embodiment is described and illustrated in the context of the use and operation of a wireless device, the scope of the invention extends to other applications where convenient and efficient data transmission is desired. Furthermore, while the foregoing description has been with reference to particular embodiments of the invention, it will be appreciated that these are only illustrative of the invention and the changes may be made to those embodiments without departing from the principles of invention, the scope of which is defined by the appended claims.

1. For use in a communication interface for communication between a wireless device and the communication interface to gather uploaded information from the wireless device, the communication interface being configured to communicate with other devices communicating with a network and configured to facilitate data communication between the wireless device and other devices connected to the network to send and otherwise consume data pertaining to a wireless user, a computer readable medium having stored thereon a plurality of sequences of instructions, said sequences of instructions including instructions that, when executed by a processor, cause said processor to perform the steps of:
receiving a data packet content and user information from a wireless device;
retrieving content data from the wireless device for transmission;
automatically transmitting the content data to a data application server that is configured to process the content data to at least one predetermined destination.

2. A processor according to claim 1, wherein the processor further performs the steps of:
receiving a packet having an embedded information address and command from a wireless device to establish a communication link with an application server;
establishing a communication link with the application server; and
transmitting the data packet to the application server that is configured to process the content data to at least one predetermined destination.

3. A processor according to claim 2, wherein the information address is a URL address of an application server that is the destination to where the content data is to be transmitted.

4. A processor according to claim 1, wherein the communication interface communicates with an application server configured to automatically transmit the content data to a predetermined destination.

5. A processor according to claim 1, wherein the communication interface communicates with an application server configured to automatically transmit the content data to an internet address.

6. A processor according to claim 1, wherein an email address is assigned to the photo data, the processor being configured to attach the photo data to an email message and to send the message with the photo data attached.

7. A wireless communication interface terminal, comprising:
a wireless communication interface configured to communicate with a wireless device;
a network interface configured to facilitate communication between the communication interface and a network, where the network is configured to facilitate communication among devices that communicate with the network;
a server configured to communicate with other devices communicating with the network via the network interface, configured to communicate with the wireless device via the wireless communication interface and being further configured to facilitate data communication between the wireless device and other devices via the network, a computer readable medium having stored thereon a plurality of sequences of instructions, said sequences of instructions including instructions that, when executed by a processor, cause said processor to perform the steps of:
establishing communication link with the application server;
retrieving wireless user related information and content from the wireless device; and
communicating with the application server to transmit user information received from the wireless device and related content.

8. A communication interface according to claim 7, wherein the sequences of instructions further includes instructions that, when executed by a processor, cause said processor to perform the steps of:
retrieving photo data from the wireless device for storage and transmission;
automatically transmitting the photo to the data application server according to a wireless user's predetermined destination information; and
forwarding the photo data to at least one predetermined destination.

9. A computer readable medium according to claim 7, further comprinsing receiving a packet having an embedded information address and command from a wireless device that is enabled with a protocol to establish a communication link with an application server configured to communicate with the communication interface; wherein receiving the data packet further includes receiving a data packet having a header containing user information pertaining to the intended destination of the content.

10. A computer readable medium according to claim 7 wherein the wireless communication interface is configured to receive data signals from a mobile phone, and wherein the step of receiving the data packet further includes receiving a data packet having a network address location to which the wireless device is configured to communicate to obtain localized information.

11. A computer readable medium according to claim 7 wherein the wireless communication interface is configured to receive data signals from a mobile phone, and to transmit photo data to the application server for further operation.

12. A computer readable medium according to claim 11, wherein the application server is configured to forward the photo data to another location.

13. A computer readable medium according to claim 11, wherein the application server is configured to forward the photo data via an email message.

14. A computer readable medium according to claim 7 wherein the wireless communication interface is configured to receive data signals from a mobile phone, and to transmit video data to the application server for further operation.

15. A computer readable medium according to claim 7 wherein the wireless communication interface is configured to receive data signals from a mobile phone, and to transmit video and audio data to the application server for further operation.

16. A computer readable medium according to claim 7, further comprising communicating with an application server in a manner to obtain localized information relevant to the location where a wireless device user is located.

17. A computer readable medium according to claim 7, further comprising communicating with an application server in a manner to obtain content relevant to the location where a wireless device user is located.

18. A computer readable medium according to claim 7, further comprising communicating with an application server in a manner to obtain music content relevant to the location where a wireless device user is located and to transmit the music content to the wireless device.

19. A computer readable medium according to claim 7, further comprising retrieving a data packet by receiving a data packet having a header configured under the Bluetooth protocol to transmit content to an application server, where the application server is configured to transmit content to a predetermined destination.

20. For use in a system having a communication interface for communication between a wireless device and the communication interface, the communication interface being configured to communicate with other devices communicating with a network and configured to facilitate data communication between the wireless device and other devices connected to the network to retrieve and otherwise consume information by receiving a data signal from a wireless device that is configured to establish a communication link with the interface, an application server configured to receive uploaded user data from an interface, the application server including a processor configured to automatically process the uploaded user data according to predetermined user preferences.

21. An application server according to claim 20, wherein the automatic process is storing photo data.

22. An application server according to claim 20, wherein the automatic process is storing and forwarding photo data.

23. An application server according to claim 20, wherein the automatic process is storing and forwarding photo data to an email address.

24. An application server according to claim 20, wherein the automatic process is storing and forwarding uploaded user data to an email address.

25. An application server according to claim 20, further comprising
a user interface configured to establish a user identification (ID) and to establish user preferences directed to defining predetermined operations to be performed at the request of a user;
parsing code configured to parse out the user ID from a data received from a user;
application code configured to retrieve predetermined user preferences according to the user ID.

26. An application server according to claim 25, further comprising application data processing code configured to create an email message, attached uploaded data to the email message, and to transmit the email message to at least one predetermined email address according to the user preferences.

27. An application server according to claim 25, further comprising application data processing code configured to send information requested by a user according to the user location.

28. An application server according to claim 25, wherein the uploaded data received by the application server includes location information pertaining to a user location, the application data processing code, retrieving localized information according to the user location and forwarding the location related data to the wireless device.

29. An application server according to claim 21, further comprising statistics code for generating a statistics report to system administrator
